(19) United States
(12) Patent Application Publication
(10) Pub. No.: US 2006/0053102 A1
(43) Pub. Date: Mar. 9, 2006

(54) Method of executing java application and mobile communication terminal using the same

(75) Inventor: Sang Jin Kim, Seoul (KR)

Correspondence Address: JONATHAN Y. KANG, ESQ.;LEE, HONG, DEGERMAN,, KANG & SCHMADEKA, 801 S. Figueroa Street, 14th Floor, Los Angeles, CA, 90017, US

(73) Assignee: LG Electronics Inc.

(21) Appl. No.: 11/223,555

(22) Filed: Sep. 9, 2005

(30) Foreign Application Priority Data
Sep. 9, 2004 (KR) 10-2004-0072149

(51) Int. Cl. G06F 17/30

(52) U.S. Cl. 707/3

(57) ABSTRACT

A method of executing Java application and mobile communication terminal using the same are disclosed, by which Java applications can be utilized in the mobile communication terminal. The present invention includes the steps of: reading a midlet calling type API having an argument; parsing the argument to identify a suite type midlet, a preset sign, and a general type midlet; searching for the general type midlet either within the suite type midlet or outside the suite type midlet responsive to whether the preset sign is present; and executing the general type midlet.

### CROSS-REFERENCE TO RELATED APPLICATIONS

This application claims the benefit of the Korean Patent Application No. 10-2004-0072149, filed on Sep. 9, 2004, which is hereby incorporated by reference as if fully set forth herein.

### FIELD OF THE INVENTION

The present invention relates to Java applications, and more particularly, to a method of executing Java applications and a mobile communication terminal using the same. Although the present invention is suitable for a wide scope of applications, it is particularly suitable for utilizing Java applications in a mobile communication terminal.

### BACKGROUND OF THE INVENTION

Generally, Java is categorized as a Java application or a Java Applet. A Java application corresponds to a format operated on a terminal such as a PC or a mobile communication terminal. A Java Applet corresponds to a format operated on the Internet. Specifically, a Java application that can be implemented in a mobile communication terminal in a wireless environment is called a midlet. In other words, the midlet means an application that conforms to the Mobile Information Device Profile (MIDP) standard, the MIDP being a set of Java 2 Platform Micro Edition (J2ME) Application Protocol Interfaces (APIs) that define how software applications interface with cellular phones.

The midlet consists of a Java archive (jar) file and a Java application descriptor (jad) file. The jar file is an execution file to substantially execute the midlet and the jad file is a description file that contains a general description of the midlet.

Once the midlet is provided over the Internet by a content provider (CP), a mobile communication terminal having a wireless application protocol (WAP) browser is able to download the midlet using a WAP gateway.

The midlet can be classified as a general type or a suite type. The general type is a midlet consisting of one jar file, and the suite type is a midlet suite comprising a plurality of jar files.

The following is an example showing general type midlets and a suite type midlet containing test1, test2 and test2 stored in a mobile communication terminal extended file system (EFS) consisting of a games folder and a tools folder.

| Games folder: | Pman.jar | (general type) |
|---|---|---|
| | Tetris.jar | (general type) |
| | Test1.jar | (general type) |
| Tools folder: | Mviewer.jar | (general type) |

| | |
|---|---|
| TestAlerts.jar | (general type) |
| MidletSuite.jar | (suite type) |

| | |
|---|---|
| Test1.jar | (general type) |
| Test2.jar | (general type) |
| Test3.jar | (general type) |

A problem exits in the related art when executing an API that calls another midlet. An example is the function MidletExitURI( ), a midlet calling type API. MidletExitURI( ) is the API function that enables execution of the argument contained within the parenthesis, for example MidletExitURI(midlet: test1) enables the execution of “midlet: test1” after ending the current midlet.

In the above example, the related art is unable to determine whether the general type midlet “test1.jar” in the games folder or the suite type midlet “test1.jar” in the tools folder is to be executed. The result is that the “test1” midlet that was called most recently is executed again.

### SUMMARY OF THE INVENTION

Accordingly, the present invention is directed to a method of executing Java applications and a mobile communication terminal using the method that substantially obviate one or more problems due to limitations and disadvantages of the related art.

An object of the present invention is to provide a method of executing Java applications and a mobile communication terminal using the same, by which the Java applications can be utilized in the mobile communication terminal.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method of executing Java applications according to the present invention includes: identifying a midlet calling type API, deciding whether the target midlet to be called is included in a suite type midlet based on the argument of the API, and depending upon the type of midlet, searching for a midlet having the same name as the target either inside a midlet suite or outside the midlet suite, and executing the target midlet.

Preferably, the argument includes a preset sign to indicate whether the target midlet is of a general type or a suite type.

More preferably, if the target midlet is of the suite type, the argument comprises the name of the target midlet, the preset sign and the name of the midlet suite.

Preferably, the midlet calling type API is MidletExitURI.

In another aspect of the present invention, in executing a Java application, a mobile communication terminal comprises an EFS storing a plurality of midlets and a control unit capable of executing the stored midlets. The control unit is capable of identifying a midlet calling type API, deciding whether the target midlet to be called is included in a suite type midlet based on an argument of the API, and depending upon the type of midlet, searching for a midlet having the same name as the target either inside a midlet suite or outside the midlet suite, and executing the target midlet.

It is to be understood that both the foregoing general description and the following detailed description of the present invention are exemplary and explanatory and are intended to provide further explanation of the invention as claimed. The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this application, illustrate embodiments of the invention and together with the description serve to explain the principle of the invention.

FIG. 1 is a block diagram of a mobile communication terminal according to the present invention.

FIG. 2 is a flowchart of a method of executing Java application according to the present invention.

### DETAILED DESCRIPTION OF THE PREFERRED EMBODIMENTS

Reference will now be made in detail to the preferred embodiments of the present invention, examples of which are illustrated in the accompanying drawings. Wherever possible, the same reference numbers will be used throughout the drawings to refer to the same or like parts.

When a midlet calling type API calls a general type midlet included in a suite type midlet, the argument of the API is designated to include not only a name of the general type midlet, but also a name of the suite type midlet including the general type midlet.

For the detailed explanation, the example of storing midlets in the related art is referred to again.

| Games folder: | Pman.jar | (general type) |
|---|---|---|
| | Tetris.jar | (general type) |
| | Test1.jar | (general type) |
| Tools folder: | Mviewer.jar | (general type) |

| | |
|---|---|
| TestAlerts.jar | (general type) |
| MidletSuite.jar | (suite type) |

| | |
|---|---|
| Test1.jar | (general type) |
| Test2.jar | (general type) |
| Test3.jar | (general type) |

To execute the midlet “Test1.jar” of the Tools folder, the argument of the MidletExitURI( ) API contains the name of the mitdlet to be executed “Test1”, the location of the midlet “MidletSuit”, and a preset sign “1”. Therefore, the complete argument is “midlet: MidletSuite/Test1”. In order to execute the midlet “Test1” of the Games folder, the complete argument is “midlet: test1”.

In brief, the midlet calling type API has an argument of “midlet: suite type midlet name/general type midlet name” to call a general type midlet within a suite type midlet and an argument of “midlet: general type midlet name” to call a general type midlet that is not included in a suite type midlet.

When the arguments of the midlet calling type API are as described above, the midlet calling type API is able to distinguish between general type midlets having the same name located within a suite type midlet or outside a suite type midlet.

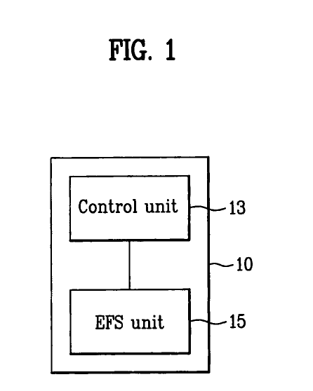

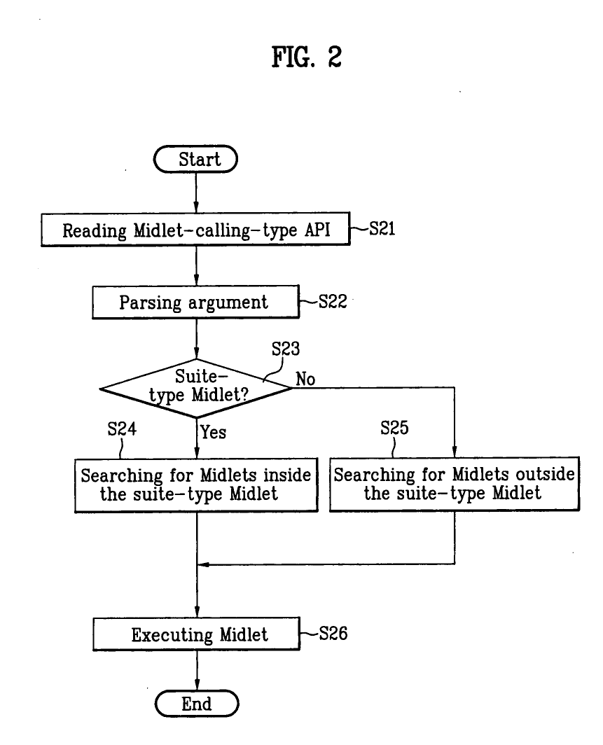

A method of executing a Java application to execute a midlet calling type API having the inventive argument is explained with reference to FIG. 1 and FIG. 2.

Referring now to FIG. 1, a mobile communication terminal 10 is shown having a control unit 13 for reading a midlet calling type API and for executing a midlet identified by the midlet calling type API. Midlets of both the general type and suite type may be stored in the EFS unit 15.

Referring now to FIG. 2, the control unit 13 reads the argument of of the midlet calling type API (S22) in order to parse the argument for the preset character (S23). In one embodiment as described in the above example, the control unit 13 decides whether the preset character of “/” is included in the argument. The character “/” is exemplary and any character that would not otherwise appear in a midlet name may be used such as a backward slash (“\”).

If the preset character is contained within the argument, the control unit 13 searches midlets inside the suite type midlet within an EFS unit 15 for a midlet having the same name as the target midlet (S24). If not, the control unit 13 searches midlets outside the suite type midlet for a midlet having the same name as the target midlet (S25).

The control unit 13 then executes the searched midlet within the EFS unit 15 (S26).

Accordingly, the present invention finds the correct provider-specific midlet within the mobile communication terminal correctly even if names of midlets stored in the EFS are the same.

Moreover, as mentioned in the foregoing description, the present invention is applicable to the case when the general type midlet has the same name of another general type midlet in a suite type midlet, and can be extended to a concept that two different general type midlets, but having the same name, can be downloaded and stored into two different corresponding directories respectively.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method of executing Java applications, the method comprising:
reading a midlet calling type application protocol interface (API) having an argument;
parsing the argument to identify a suite type midlet, a preset sign, and a general type midlet;
searching for the general type midlet either within the suite type midlet or outside the suite type midlet responsive to whether the preset sign is present; and
executing the general type midlet.

2. The method of claim 1, wherein the argument of the midlet calling type API comprises the suite type midlet, the preset sign, and the general type midlet.

3. The method of claim 2, wherein the general type midlet is within the suite type midlet.

4. The method of claim 1, wherein the argument of the midlet calling type API comprises the general type midlet.

5. The method of claim 1, wherein the midlet calling type API comprises MidletExitURI.

6. A mobile communication terminal comprising:
an extended file system unit storing a plurality of midlets; and
a control unit,
wherein the control unit reads a midlet calling type application protocol interface (API) having an argument,
wherein the control unit parses the argument to identify a suite type midlet, a preset sign, and a general type midlet,
wherein the control unit searches for the general type midlet either within the suite type midlet or outside the suite type midlet responsive to whether the preset sign is present, and
wherein the control unit executes the general type midlet.

7. The mobile communication terminal of claim 6, wherein the argument of the midlet calling type API comprises the suite type midlet, the preset sign, and the general type midlet.

8. The mobile communication terminal of claim 7, wherein the general type midlet is within the suite type midlet.

9. The mobile communication terminal of claim 6, wherein the argument of the midlet calling type API comprises the general type midlet.

10. The mobile communication terminal of claim 6, wherein the midlet calling type API comprises MidletExitURI.

11. A system for executing Java applications, the system comprising:
a mobile communications terminal, wherein the mobile communications terminal further comprises an extended file system unit storing a plurality of midlets; and
a means for executing Java applications.

12. The system of claim 11, wherein the means for executing Java applications further comprises:
a means for reading a midlet calling type application protocol interface (API) having an argument;
a means for parsing the argument to identify a suite type midlet, a preset sign, and a general type midlet;
a means for searching for the general type midlet either within the suite type midlet or outside the suite type midlet responsive to whether the preset sign is present; and
a means for executing the general type midlet.

13. The system of claim 12, wherein the argument of the midlet calling type API comprises the suite type midlet, the preset sign, and the general type midlet.

14. The system of claim 13, wherein the general type midlet is within the suite type midlet.

15. The system of claim 12, wherein the argument of the midlet calling type API comprises the general type midlet.

16. The system of claim 12, wherein the midlet calling type API comprises MidletExitURI.
